(19) United States
(12) Patent Application Publication
(10) Pub. No.: US 2014/0307461 A1
(43) Pub. Date: Oct. 16, 2014

(54) Vehicle Tail-Light Unit

(71) Applicant: Yao Hung Huang, Rende Township (TW)

(72) Inventor: Yao Hung Huang, Rende Township (TW)

(21) Appl. No.: 13/861,142

(22) Filed: Apr. 11, 2013

(51) Int. Cl. B60Q 1/26; B60Q 1/30; B60Q 1/34; B60Q 1/44

(52) U.S. Cl. CPC B60Q 1/26; B60Q 1/44; B60Q 1/30; B60Q 1/34
USPC 362/541

(57) ABSTRACT

A vehicle tail-light unit (VTLU) that is designed to be attached to a rear structure of a vehicle such as a towed trailer. The VTLU includes a plurality of voltage regulators that control the illumination of a series of LEDs. The LEDs produce a red light when the vehicle brakes are depressed, a yellow light when either a right-turn or left-turn lever is depressed and a white light when the vehicle is placed in reverse. The VTLU is enclosed in a housing that can be configured as a triangle, a circle or a rectangle and can include a red reflector.

### TECHNICAL FIELD

The invention generally pertains to vehicle warning lights, and more particularly to a vehicle tail-light unit that attaches to a rear structure of a vehicle.

### BACKGROUND ART

Conventional vehicle tail-light warning units typically are comprised of a reflection plate which is attached to a rear structure of a vehicle. The reflector reflects the head lights of a following vehicle to warn the following vehicles that there is an obstruction ahead. However, the reflection cannot provide sufficient light when the vehicle is located in a dark area such as when the vehicle is parked beside a dark roadside and the engine is off. The inadequate light provided by the reflector may cause a dangerous situation for the drivers of the following vehicles. The solution to this problem is to provide a VTLU which can adequately alert the driver of any following vehicle(s).

A search of the prior art did not disclose any literature or patents that read directly on the claims of the instant invention.

### DISCLOSURE OF THE INVENTION

The vehicle tail-light unit (VTLU) is designed to provide a light source that is attached to a vehicle such as a trailer. The VTLU functions in combination with a vehicle that produces a brake signal, a right-turn signal, a left-turn signal and a reverse signal. The VTLU in its basic design is comprised of
A. A plurality of electronic control circuits (ECCs), wherein each the ECC comprises:
   (1) a plurality of voltage regulators (VRs), each having an input and an output, wherein the input is connected to a particular vehicle-provided signal,
   (2) a plurality of LEDs having an input connected to the output of one of the respective VRs, and an output connected to circuit ground and,
B. A housing having a front surface that selectably displays the plurality of LEDs and a rear surface having means for attaching the housing to a rear structure of a vehicle.

The plurality of ECCs can range from two to six ECCs, and the plurality of the voltage regulators (VRs) ranges from two to six VRs. Each VR functions in combination with a protection diode, a first filter capacitor, a second filter capacitor and a current limiting resistor.

The plurality of LEDs are located:
A. In a first ECC and provide a red light when the first ECC is applied the vehicle's brake light signal,
B. In a second ECC and provide a yellow light when the second ECC is applied the vehicle's right-turn signal,
C. In a third ECC and provide a yellow light when the third ECC is applied the vehicle's left-turn signal, and
D. In a fourth ECC and provide a white light when the fourth ECC is applied the vehicle's reverse signal.

The housing has a shape that is selected from the group consisting of a triangle, a circle, a rectangle or a variation thereof. When the housing is attached to the right side of a vehicle the yellow right-turn LEDs are located on the right side of the housing. Likewise, when the housing is attached to the left side of a vehicle, the yellow left-turn LEDs are located on the left side of the housing.

In addition to the primary object of the invention it is also an object of the invention to provide a VTLU that:
can be produced as san OEM product or as an aftermarket product,
can potentially reduce insurance costs,
is easily installed,
is reliable and relatively maintenance free,
adds value to a vehicle,
can be used on many different types of vehicles,
can be removably attached for use on multiple vehicles, and
is cost effective from both a manufacturer's and consumer's point of view.

These and other objects and advantages of the present invention will become apparent from the sub sequent detailed description of the preferred embodiment and the appended claims taken in conjunction with the accompanying drawings.

### BRIEF DESCRIPTION OF THE DRAWINGS

FIG. 1 is a block diagram of the vehicle tail-light unit (VTLU) showing the relative location of the electronic control units (ECUs) that are connected to the vehicle via a protection diode.

FIG. 2 is a schematic diagram of the VTLU.

FIG. 3 is an isometric view of the housing having a triangular shape.

FIG. 4 is an isometric view of a housing having a circular shape.

FIG. 5 is an isometric view of the housing having a rectangular shape.

FIG. 6 is an isometric view of a trailer having a pair of housings attached to a rear structure of the trailer.

### BEST MODE FOR CARRYING OUT THE INVENTION

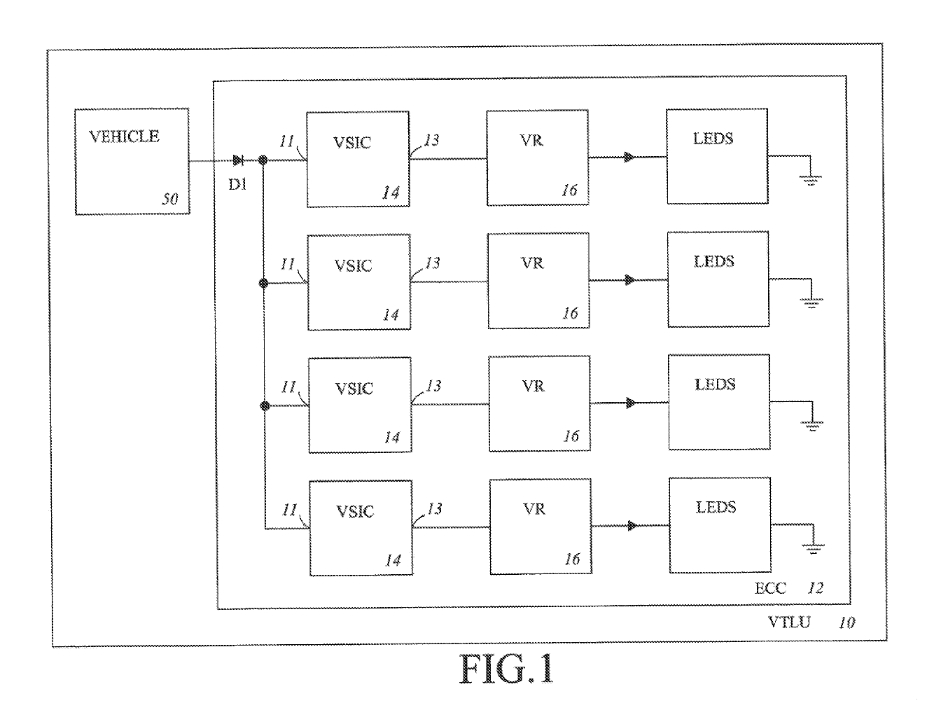

The best mode for carrying out the invention is presented in terms that disclose a preferred embodiment of a vehicle tail-light unit (VTLU) 10. The preferred embodiment, as shown in FIGS. 1-6, functions in combination with a vehicle 50 that produces a vehicle signal corresponding to a brake light, a right-turn light, a left-turn light and a reverse light. The inventive elements that function in combination with the vehicle elements consist of a plurality of electronic control circuits (ECC) 12 and a housing 22 that encloses the elements that comprise the ECC 12.

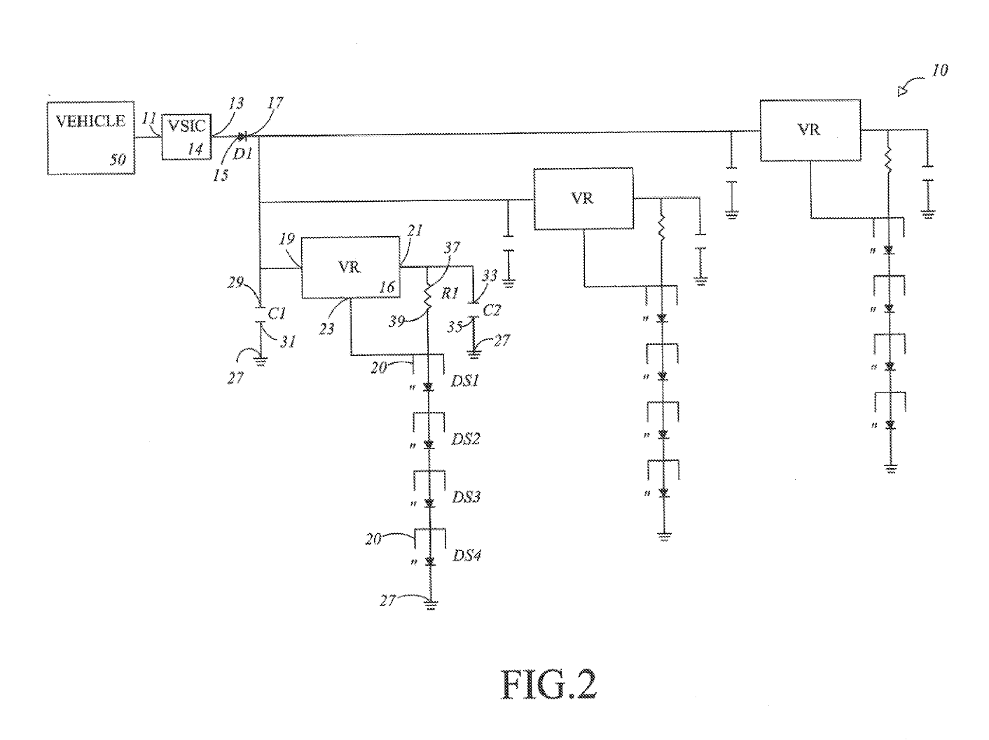

The ECC 12, as shown in FIGS. 1 and 2, is comprised of a vehicle signal interface circuit (VSIC) 14, a protection diode D1, a plurality of voltage regulators (VRs) 16, a first filter capacitor C1, a second filter capacitor C2, a current limiting resistor R1 and a plurality of LEDs (DS1-DS4). The plurality of ECCs 12 can range from two to six ECCs 12, and the plurality of VRs 16 can also range from two to six VRs 16.

For brevity, the block diagram, shown in FIG. 1, depicts the VTLU 10 with only one ECC 12 that includes four input lines. Likewise, the schematic diagram, as shown in FIG. 2, shows only one of the ECCs 12 with reference designations since the remaining ECCs 12 are identical. Also, for the purpose of the instant application a vehicle is defined as an automobile, a SUV, a truck, a trailer and military vehicles.

As shown in FIGS. 1 and 2, the VSIC 14 has an input 11 and an output 13, wherein the input is connected to a particular vehicle-provided signal that is selected by the driver of the vehicle 50. The protection diode D1 has an input 15 and an output 17, wherein the input 15 is connected to the output 13 of the VSIC 14. The diode D1 protects the ECC 12 in the event that the power is connected in reverse. It also provides a 0.6-volt d-c drop in the power. Hence, if 12-volts d-c is applied to pin 15 of the VSIC 14 there would be 11.4-volts, d-c at the output 17 of the diode D1, thus aiding in the voltage drop needed from 12-volts to operate the LEDs DS1-DS4, which operate on 1.2-volts d-c.

The plurality of VRs 16 each have an input 19 and an output 21, wherein the input 19 is connected to the output of the protection diode D1. All three VRs 16 are identical and are each comprised of an LD117AL-1.2 integrated circuit. The 1.2 refers to the output voltage of the VR. Although a particular VR is referenced, the VR is not limited to this part number as any 1.2-volt regulator will suffice. As shown in FIG. 2, the input voltage from the diode Dl is applied to pin 3 of each VR 16, which also has connected to the first capacitor C1.

The first capacitor C1 which functions as a filter capacitor has an input 29 and an output 31, wherein the input 39 is connected to the input 19 of each of the VRs 16, and the output 31 of capacitor C1 is connected to circuit ground 27. The second filter capacitor C2 also has an input 33 and an output 35, whereon the input 33 is connected to the output 21 of each VR 16, and the output 35 is connected to circuit ground 27. The current limiting resistor R1 has an input 37 and an output 39, wherein the input is connected to the output 26 of each VR 16, and the output 39 is connected in series with a plurality of series connected LEDs DS1-DS4. The number of LEDs is limited to the current rating of the VRs.

The plurality of LEDs are located:
a) in a first ECC and provide a red light when the first ECC is applied the vehicle's brake light signal,
b) in a second ECC and provide a yellow light when the second ECC is applied the vehicle's right-turn signal,
c) in a third ECC and provide a yellow light when the third ECC is applied the vehicle's left-turn signal, and
d) in a fourth ECC and provide a white light when the fourth ECC is applied the vehicle's reverse signal.

As shown in FIG. 2, across the anode of each LED is attached a heat sink 20. The heat sink protects the LEDs from high temperature spikes.

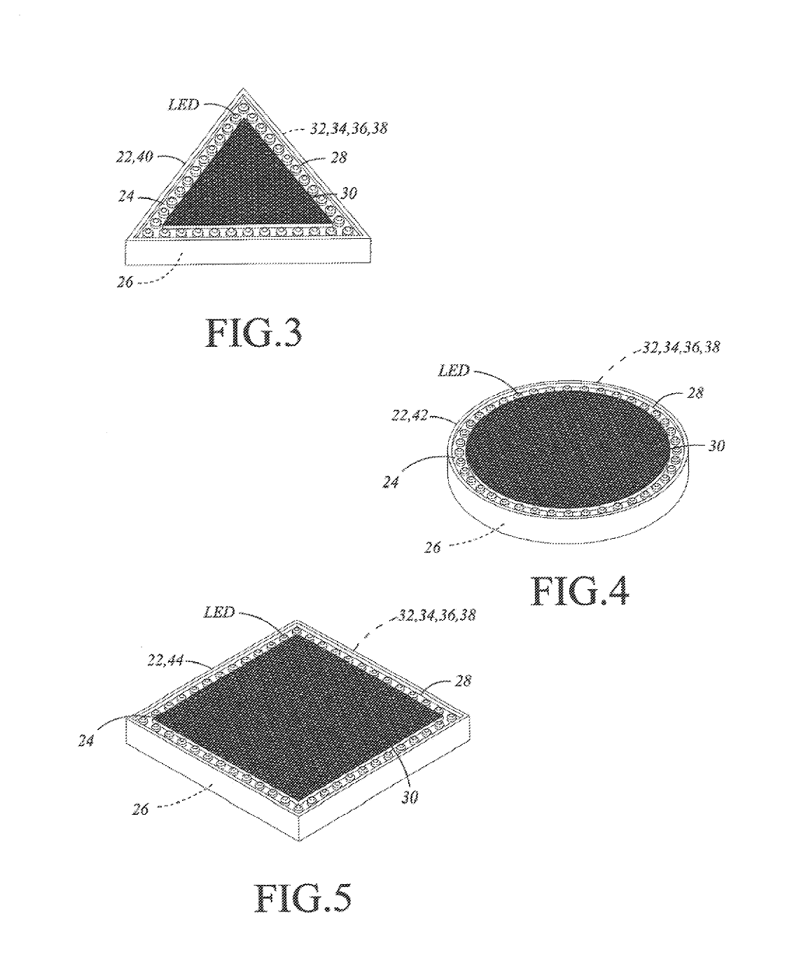

The housing 22, as shown in FIGS. 3-6, has a shape that can consist of a triangle 36, as shown in FIG. 3; a circle 40, as shown in FIG. 4; a rectangle 42, as shown in FIG. 5; or a variation thereof. The LEDs are located adjacent the inward periphery of the housing 22. As also shown in FIGS. 3-6, the housing 22 includes a substantially centered reflector that reflects a red color to alert an oncoming vehicle of a potentially dangerous obstruction. The housing 22 is hermetically sealed and is attached to the rear structure of the vehicle 50 by means of a hook 32, an adhesive 34, a double-sided tape 36 or a magnet 38.

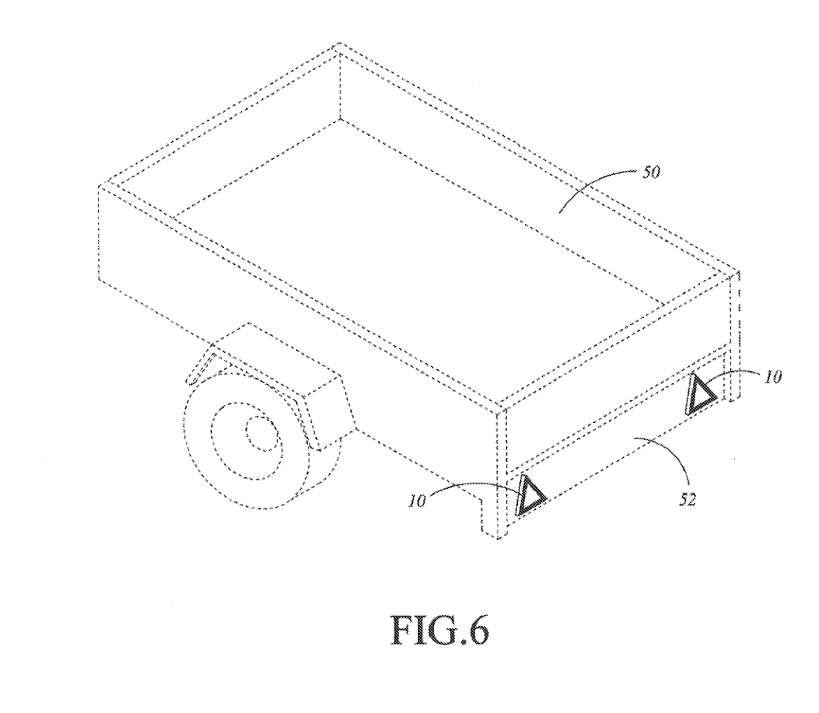

As shown in FIG. 6, when the housing 22 is attached to the right side of a vehicle 50, the yellow right-turn LEDs are located on the right side of the housing. Likewise, when the housing attached to the left side of the vehicle, the yellow left-turn LEDs are located on the left side of the housing 22. In other words, the yellow LEDs are always located on the outer edge of the housing 22 on the side they represent.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A vehicle tail-light unit (VTLU) that functions in combination with a vehicle that produces a brake signal, a right-turn signal, a left-turn signal and a reverse signal, said VTLU comprising:
a) a plurality of electronic control circuits (ECCs), wherein each said ECC comprises:
(1) a plurality of voltage regulators (VRs) each having an input and an output, wherein the input is connected to a particular vehicle-provided signal,
(2) a plurality of LEDs having an input connected to the output of a respective said VRs, and an output connected to circuit ground and,
b) a housing having a front surface that selectably displays said plurality of LEDs and a rear surface having means for attaching the housing to a rear structure of a vehicle.

2. The VTLU as specified in claim 1 wherein the plurality of said. ECCs ranges from two to six ECCs.

3. The VTLU as specified in claim 1 wherein the plurality of said voltage regulators (VRs) ranges from two to six VRs.

4. The VTLU as specified in claim 3 wherein each said VR further comprises:
a) a protection diode connected to the input of said plurality of VRs,
c) a filter capacitor having an input and an output, wherein the input is connected to the output of each said VR, and the output is connected to circuit ground, and
d) a current limiting resistor having an input and an output, wherein the input is connected to the input of each said VR, and the output is connected to circuit ground.

5. The VTLU as specified in claim 1 wherein said plurality of LEDs are located:
a) in a first said ECC and provide a red light when said first ECC is applied the vehicle's brake light signal,
b) in a second said ECC and provide a yellow light when said second ECC is applied the vehicle's right-turn signal,
c) in a third said ECC and provide a yellow light when said third ECC is applied the vehicle's left-turn signal, and
d) in a fourth said ECC and provide a white light when said fourth ECC is applied the vehicle's reverse signal.

6. The VTLU as specified in claim 5 further comprising a heat sink located around the anode of each said LEDs.

7. The VTLU as specified in claim 1 wherein said housing has a shape selected from the group consisting of a triangle, a circle, a rectangle or a variation thereof, wherein said LEDs are located adjacent the inward periphery of said housing.

8. The VTLU as specified in claim 1 wherein when said housing is attached to the right side of a vehicle the yellow right-turn LEDs are located on the right side of said housing, likewise when said housing is attached to the left side of a vehicle the yellow left-turn LEDs are located on the left side of said housing.

9. A vehicle tail-light unit (VTLU) that functions in combination with a vehicle that produces a brake signal, a right-turn signal, a left-turn signal and a reverse signal, said VTLU comprising:
a) a plurality of electronic control circuits (ECCs), wherein each ECC comprises:
(1) a vehicle signal interface circuit (VSIC) having an input and an output, wherein the input is connected to a particular vehicle provided signal, (2) a protection diode (D1) having an input and an output, wherein the input is connected to the output of the VSIC, (3) a plurality of voltage regulators (VR) each having an input and an output, wherein the input is connected to the output of the protection diode (Dl), (4) a plurality of series connected LEDs having an input connected via a current limiting resistor to the output of a respective VR, and an output connected to circuit ground, and b) a housing having a front surface that selectably displays the plurality of LEDs and a rear surface having means for attaching said housing to a rear structure of a vehicle.

10. The VTLU as specified in claim 8 wherein said plurality of ECCs ranges from two to six ECCs.

11. The VTLU as specified in claim 8 wherein the plurality of voltage regulators (VRs) ranges from two to six VRs.

12. The VTLU as specified in claim 11 wherein each said VR further comprises:
a) a filter capacitor having an input and an output, wherein the input is connected to the input of each said VR, and the output is connected to circuit ground,
b) a filter capacitor having an input and an output, wherein the input, is connected to the output of each said VR, and the output is connected to circuit ground, and
c) a current limiting resistor having an input and an output, wherein the input is connected to the output of each said VR, and the output is connected in series with said plurality of LEDs.

13. The VTLU as specified in claim 8 wherein said plurality of said LEDs are located:
a) in a first said ECC and provide a red light when said first ECC is applied the vehicle's brake light signal,
b) in a second said ECC and provide a yellow light when said second ECC is applied the vehicle's right-turn signal,
c) in a third said ECC and provide a yellow light when said third ECC is applied the vehicle's left-turn signal, and
d) in a fourth said ECC and provide a white light when said fourth ECC is applied the vehicle's reverse signal.

14. The VTLU as specified in claim 8 wherein the shape of said housing is selected from the group consisting of a triangle, a circle, a rectangle or a variation thereof.

15. The VTLU as specified in claim 14, wherein said LEDs are located adjacent the inward periphery of said housing.

16. The VTLU as specified in claim 15 wherein said housing further comprises a substantially centered reflector that reflects a red light.

17. The VTLU as specified in claim 15 wherein the quantity of LEDs is dependent upon the current rating of said VR.

18. The VTLU as specified in claim 8 wherein said means for attaching said housing to a vehicle comprises a magnet, a hook, an adhesive and a double-sided tape.

19. The VTLU as specified in claim 8 wherein said housing is hermetically sealed.

20. The VTLU as specified in claim 8 wherein when said housing is attached to the right side of a vehicle the yellow right-turn LEDs are located on the right side of said housing, likewise when said housing is attached to the left side of a vehicle the yellow left-turn LEDs are located on the left side of said housing.
